(19) United States
(12) Patent Application Publication
(10) Pub. No.: US 2026/0303331 A1
(43) Pub. Date: Oct. 1, 2026

(54) SECRET SHARING CONTROL DEVICE, IN-VEHICLE DEVICE, IN-VEHICLE SYSTEM, SECRET SHARING CONTROL METHOD, AND COMPUTER PROGRAM

(71) Applicants: Sumitomo Electric Industries, Ltd., Osaka-shi, Osaka (JP); AutoNetworks Technologies, Ltd., Yokkaichi-shi, Mie (JP); Sumitomo Wiring Systems, Ltd., Yokkaichi-shi, Mie (JP)

(72) Inventor: Akihiro OGAWA, Osaka-shi, Osaka (JP)

(73) Assignees: Sumitomo Electric Industries, Ltd., Osaka-shi, Osaka (JP); AutoNetworks Technologies, Ltd., Yokkaichi-shi, Mie (JP); Sumitomo Wiring Systems, Ltd., Yokkaichi-shi, Mie (JP)

(21) Appl. No.: 19/478,655

(22) PCT Filed: Apr. 27, 2023
(86) PCT No.: PCT/JP2023/016581

§ 371 Date: Oct. 24, 2025

(51) Int. Cl. H04L 9/08; H04L 12/40

(52) U.S. Cl. CPC H04L 9/085; H04L 12/40104; H04L 2012/40273

(57) ABSTRACT

A secret sharing control device includes: an information acquiring unit configured to acquire, from a plurality of information processing units that are connected to a network, confidential suitability information of the plurality of information processing units; a distribution destination selecting unit configured to select distribution destinations of shares obtained from data using a secret sharing method from among the plurality of information processing units, based on the confidential suitability information acquired by the information acquiring unit; and a distributing unit configured to distribute the shares obtained from the data using the secret sharing method among the information processing units selected by the distribution destination selecting unit.

### CROSS-REFERENCE TO RELATED APPLICATIONS

This application is the U.S. national stage of PCT/JP2023/016581 filed on Apr. 27, 2023, the content of which is incorporated herein.

### TECHNICAL FIELD

The present disclosure relates to a secret sharing control device, an in-vehicle device, an in-vehicle system, a secret sharing control method, and a computer program.

### BACKGROUND

Security is important for an in-vehicle network. In particular, the possibility of outside leakage of information that is required to be stored in a vehicle and information communicated between the vehicle and a device must be eliminated. To this end, the information is concealed.

As the concealing method, attention has recently been given to a secret sharing method. The secret sharing method conceals information by managing, in a distributed manner, asset data that is required to be protected.

Japanese Patent No. 6322763 discloses a proposal for applying the secret sharing method to a computer network. Japanese Patent No. 6322763 discloses a technique regarding a data transfer system that transmits fragmented data (also called “shares”) obtained using the secret sharing method through transmission paths. Data is divided into a plurality of shares using the secret sharing method. According to Japanese Patent No. 6322763, when transmitting the shares to a specific recipient, a less frequently used transmission path is preferentially selected as the transmission path. The number of shares is determined based on a setting value and a random number each time the need to transmit asset data that is required to be protected arises.

The technique disclosed in Japanese Patent No. 6322763 is effective in that asset data that is required to be protected can be efficiently transmitted using the secret sharing method. However, it appears there is still room for improvement in applying the technique disclosed in Japanese Patent No. 6322763 to an in-vehicle system. The reason is that Japanese Patent No. 6322763 does not give consideration to shares that have been transmitted although there is a need to provide sufficient protection even for the shares that have been transmitted. If an operation of immediately decoding the shares that have been transmitted and discarding the original shares is constantly performed, the risk of information leakage may be low. However, in the case of an operation of storing the shares that have been transmitted and decoding the shares when needed, the technique disclosed in Japanese Patent No. 6322763 cannot provide sufficient protection.

It is an object of the present disclosure to provide a secret sharing control device, an in-vehicle device, an in-vehicle system, a secret sharing control method, and a computer program that can provide sufficient protection when storing shares.

### SUMMARY

A secret sharing control device according to one aspect of the present disclosure includes: an information acquiring unit configured to acquire, from a plurality of information processing units that are connected to a network, confidential suitability information of the plurality of information processing units; a distribution destination selecting unit configured to select distribution destinations of shares obtained from data using a secret sharing method from among the plurality of information processing units, based on the confidential suitability information acquired by the information acquiring unit; and a distributing unit configured to distribute the shares obtained from the data using the secret sharing method among the information processing units selected by the distribution destination selecting unit.

The present disclosure can be implemented not only as the secret sharing control device that includes characteristic processing units as described above, but also as a secret sharing control method that includes characteristic processing operations as described above as steps, or also as a program for causing a computer to execute the steps. Also, the present disclosure can also be implemented as a semiconductor integrated circuit that implements a portion or all of the secret sharing control device, or as a secret sharing control system that includes the secret sharing control device.

The above-described objects, other objects, features, aspects, and advantageous effects of the present disclosure will become apparent from the following detailed description of the present disclosure in conjunction with the accompanying drawings.

### Advantageous Effects

As described above, according to the present disclosure, it is possible to provide a secret sharing control device, an in-vehicle device, an in-vehicle system, a secret sharing control method, and a computer program that can provide sufficient protection when storing shares.

### BRIEF DESCRIPTION OF DRAWINGS

FIG. 1 is a block diagram showing an overall configuration of an in-vehicle system according to a first embodiment of the present disclosure.

FIG. 2 is a schematic diagram illustrating a secret sharing method.

FIG. 3 is a schematic diagram illustrating a secret sharing method.

FIG. 4 is a functional block diagram showing an overall configuration of a secret sharing control device according to the first embodiment of the present disclosure.

FIG. 5 is a flowchart illustrating a control structure of a program that implements an information acquiring unit shown in FIG. 4.

FIG. 6 is a flowchart illustrating a control structure of a program that implements an activating unit, a distribution destination selecting unit, a processing terminating unit, a secret sharing processing unit, a data protecting unit, and a distribution destination determining unit shown in FIG. 4.

FIG. 7 is a flowchart illustrating a control structure of a program that implements processing of restoring original data from shares generated using a secret sharing method.

FIG. 8 is a flowchart illustrating a control structure of a program that implements a variation of the first embodiment and corresponds to the flowchart shown in FIG. 6.

FIG. 9 is a functional block diagram showing an overall configuration and a first operation mode of an in-vehicle system according to a second embodiment of the present disclosure.

FIG. 10 is a functional block diagram showing a second operation mode of the in-vehicle system according to the second embodiment of the present disclosure.

FIG. 11 is a flowchart illustrating a control structure of a program that implements confidential data transmitting processing in the in-vehicle system according to the second embodiment of the present disclosure.

FIG. 12 a flowchart illustrating a control structure of a program that implements a step of determining distribution destination electronic control units (ECUs) and shares to be distributed shown in FIG. 11.

FIG. 13 is a hardware block diagram of a computer that implements the first embodiment and the second embodiment.

### DETAILED DESCRIPTION OF PREFERRED EMBODIMENTS

In the following description and drawings, components that are the same are given the same reference numerals. Accordingly, a detailed description of the same components will not be repeated. In addition, at least a portion of the embodiments described below may be combined in any way.

In a first aspect, a secret sharing control device according to a first aspect of the present disclosure includes: an information acquiring unit configured to acquire, from a plurality of information processing units that are connected to a network, confidential suitability information of the plurality of information processing units; a distribution destination selecting unit configured to select distribution destinations of shares obtained from data using a secret sharing method from among the plurality of information processing units, based on the confidential suitability information acquired by the information acquiring unit; and a distributing unit configured to distribute the shares obtained from the data using the secret sharing method among the information processing units selected by the distribution destination selecting unit. With this configuration, the shares obtained using the secret sharing method are distributed among information processing units that have a high level of confidential suitability. As a result, the protection of data that is required to be concealed is robustified.

In a second aspect, the secret sharing control device according to the first aspect may further include: an activating unit configured to, in response to data required to be concealed being received via the network, activate secret sharing processing that is performed on the data required to be concealed by the distribution destination selecting unit and the distributing unit. With this configuration, when data required to be concealed is received, the data is divided into a plurality of shares using the secret sharing method. These shares are distributed among information processing units that have a high level of confidential suitability. As a result, the protection of the data required to be concealed is robustified.

In a third aspect, in the secret sharing control device according to the first aspect, the information acquiring unit may collect, as the confidential suitability information, at least one of security reliability of each of the plurality of information processing units; redundancy of communication media available to the plurality of information processing units; redundancy of power supply of the plurality of information processing units; and memory capacity available to the plurality of information processing units. With this configuration, the shares obtained using the secret sharing method are distributed among information processing units that have a high level of confidential suitability and are less susceptible to communication, power supply, and memory capacity issues. As a result, the protection of the data required to be concealed is robustified.

In a fourth aspect, the secret sharing control device according to the first aspect may further include: a processing terminating unit configured to, in response to a total number of information processing units selected by the distribution destination selecting unit being less than a threshold value required by the secret sharing method to restore information, terminate processing performed on the data, which is data required to be concealed, using the secret sharing method. With this configuration, the processing is terminated when it is not possible to sufficiently perform secret sharing using the secret sharing method. As a result, when it is not possible to protect the data required to be concealed, the secret sharing method is not used, and thus the protection of data is robustified.

In a fifth aspect, the secret sharing control device according to the fourth aspect may further include: a data protecting unit configured to, in response to the processing performed on the data required to be concealed using the secret sharing method being terminated by the processing terminating unit, perform processing of protecting the data required to be concealed using a protection method that is different from the secret sharing method. With this configuration, when it is not possible to protect the data using the secret sharing method, the data can be protected using a predetermined protection method. As a result, the protection of the data required to be concealed is robustified.

In a sixth aspect, in the secret sharing control device according to the fourth aspect, the distribution destination selecting unit may determine, in response to the total number of distribution destinations being greater than or equal to the threshold value, a total number of the shares obtained using the secret sharing method to be equal to the total number of distribution destinations. As a result, the total number of shares required to be distributed among the distribution destinations can be easily determined, and the protection of the data required to be concealed can be easily robustified.

In a seventh aspect, in the secret sharing control device according to the fourth aspect, the distributing unit may include a distribution method determining unit configured to, in response to the total number of distribution destinations being greater than or equal to a threshold value set in the secret sharing method, determine a method for distributing the shares among the distribution destinations in accordance with a determining method determined based on a relationship between a total number of the shares and the total number of distribution destinations. With this configuration, the distribution destinations can be determined using an optimal method, based on the total number of distribution destinations and the total number of shares. As a result, the protection of the data required to be concealed is robustified.

In an eighth aspect, in the secret sharing control device according to the seventh aspect, the distribution method determining unit may include: a first determining unit configured to, in response to the total number of distribution destinations being greater than or equal to the threshold value set in the secret sharing method and the total number of the shares being greater than the total number of distribution destinations, determine the total number of the shares to be distributed among the distribution destinations according to the confidential suitability of the distribution destinations; and a second determining unit configured to, in response to the total number of distribution destinations being greater than or equal to the threshold value set in the secret sharing method and the total number of the shares being less than or equal to the total number of distribution destinations, determine the distribution destinations in order according to the confidential suitability of the distribution destinations. With this configuration, the distribution destinations can be determined using an optimal method, based on the relationship between the total number of distribution destinations and the total number of shares. As a result, the protection of the data required to be concealed is robustified.

In a ninth aspect, in the secret sharing control device according to the first aspect, the distribution destination selecting unit may preferentially select, as the distribution destinations, information processing units that belong to a highly independent network from among the plurality of information processing units, based on the confidential suitability information acquired by the information acquiring unit. With this configuration, even if data is leaked from a distribution destination, the possibility of data leakage from another distribution destination can be reduced. As a result, the protection of the data required to be concealed is robustified.

In a tenth aspect, in the secret sharing control device according to the first aspect, the distribution destination selecting unit may preferentially select, as the distribution destinations, information processing units that belong to a specific network from among the plurality of information processing units, based on the confidential suitability information acquired by the information acquiring unit. With this configuration, by strictly strengthening the security of the specific network, the possibility of data leakage from the distribution destinations can be reduced as compared with the case where the security of all networks is strengthened. As a result, the protection of the data required to be concealed is robustified at relatively low cost.

In an eleventh aspect, an in-vehicle device according to a second aspect of the present disclosure includes: the secret sharing control device according to any one of the first to the tenth aspects. With this configuration, the protection of the data required to be concealed is robustified in the in-vehicle device.

In a twelfth aspect, an in-vehicle system according to a third aspect of the present disclosure is an in-vehicle system including: an in-vehicle network; a plurality of information processing units that are connected to the in-vehicle network; and a secret sharing control device configured to apply a secret sharing method to data received from any one of the plurality of information processing units to generate a plurality of shares, and distributes the plurality of shares among a plurality of transmission destination information processing units selected from among the plurality of information processing units, wherein the secret sharing control device includes: an information acquiring unit that is connected to the in-vehicle network and acquires, from the plurality of information processing units, confidential suitability information of the plurality of information processing units; a distribution destination selecting unit configured to select the plurality of transmission destination information processing units as distribution destinations of the plurality of shares obtained from the data using the secret sharing method from among the plurality of information processing units, based on the confidential suitability information acquired by the information acquiring unit; and a distributing unit configured to distribute the plurality of shares obtained from the data using the secret sharing method among the plurality of transmission destination information processing units selected by the distribution destination selecting unit. With this configuration, the protection of the data required to be concealed is robustified in the in-vehicle system.

In a thirteenth aspect, a secret sharing control method according to a fourth aspect of the present disclosure includes: an acquiring step of acquiring, from a plurality of information processing units that are connected to a network, confidential suitability information of the plurality of information processing units; a selecting step of selecting distribution destinations of shares obtained from data using a secret sharing method from among the plurality of information processing units, based on the confidential suitability information acquired in the acquiring step; and a distributing step of distributing the shares obtained from the data using the secret sharing method among the information processing units selected in the selecting step. With this configuration, the protection of the data required to be concealed is robustified in the information processing units.

In a fourteenth aspect, a computer program according to fifth aspect of the present disclosure causes a computer to function as: an information acquiring unit configured to acquire, from a plurality of information processing units that are connected to a network, confidential suitability information of the plurality of information processing units; a distribution destination selecting unit configured to select distribution destinations of shares obtained from data using a secret sharing method from among the plurality of information processing units, based on the confidential suitability information acquired by the information acquiring unit; and a distributing unit configured to distribute the shares obtained from the data using the secret sharing method among the information processing units selected by the distribution destination selecting unit. With this configuration, the protection of the data required to be concealed is robustified in the information processing units.

Specific examples of a secret sharing control device, an in-vehicle device, an in-vehicle system, a secret sharing control method, and a computer program according to embodiments of the present disclosure will be described below with reference to the drawings. It is to be noted that the present disclosure is not limited to the examples given below. The scope of the present disclosure is indicated by the appended claims, and all changes that come within the meaning and range of equivalency of the claims are intended to be embraced within the scope of the present disclosure.

### First Embodiment

### Configuration

### Overall Configuration

FIG. 1 shows an overall configuration of an in-vehicle system 50 according to a first embodiment. Referring to FIG. 1, the in-vehicle system 50 includes: an in-vehicle device 60 that is mounted on a vehicle and assists in driving the vehicle, based on information obtained through communication with an external server, roadside equipment devices, vehicles, and the like via a wireless communication 74 and information obtained from a plurality of sensors mounted on the vehicle; and an in-vehicle network 62 that provides a communication environment between the in-vehicle device 60 and the plurality of sensors as well as between the in-vehicle device 60 and many other components including ECUs mounted on the vehicle. The in-vehicle device 60 functions as a relay device that relays communication between the ECUs as well as between the ECUs and outside of the in-vehicle system.

The in-vehicle device 60 includes: an information processing device 70 for performing various types of information processing operations such as protecting data transmitted and received between the ECUs connected to the in-vehicle network 62 as well as between the in-vehicle device 60 and the outside of the in-vehicle system using a secret sharing method; and a wireless communication device 72.

The information processing device 70 includes: a secret sharing control device 90 that is connected to the wireless communication device 72; and a plurality of types of network interfaces (I/Fs) including a network I/F 92 and a network I/F 94 that are connected to networks included in the in-vehicle network 62. The secret sharing control device 90 is actually implemented by a program executed by computer hardware. The network I/F 92 is, for example, an interface for a network that performs communication using a Transmission Control Protocol/Internet Protocol (TCP/IP), and the network I/F 94 an interface for a network that performs communication using a Controller Area Network (CAN). Needless to say, the configuration of the in-vehicle network is not limited thereto. For example, it is also possible to use a CAN with Flexible Data Rate (CAN FD), a Local Interconnect Network (LIN), a Clock Extension Peripheral Interface (CXPI), and the like.

In this example, the in-vehicle network 62 includes a network 110, a network 112, a network 114, a network 116, and a network 118. In these networks, the networks 110 and 112 are, for example, CAN networks, and the networks 114, 116, and 118 are, for example, TCP/IP networks. In these networks, for example, the networks 110 and 112 are physically connected by the network I/F 92, but logically separated from each other. The networks 114, 116, and 118 are also physically connected, but logically separated from each other. Note, however, that there may be a case where some of terminals connected to these networks form a logical network with each other.

The network 110 includes an ECU 400, an ECU 402, and an ECU 404. The network 112 includes an ECU 410, an ECU 412, and an ECU 414.

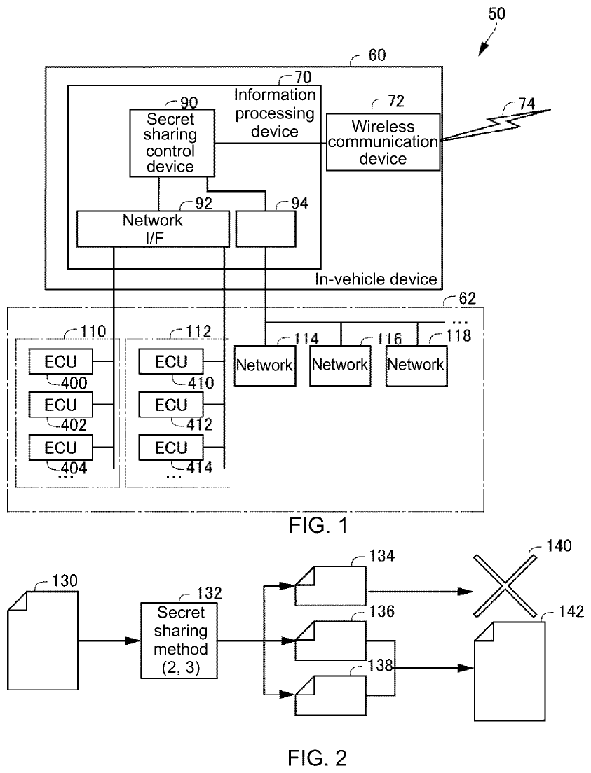

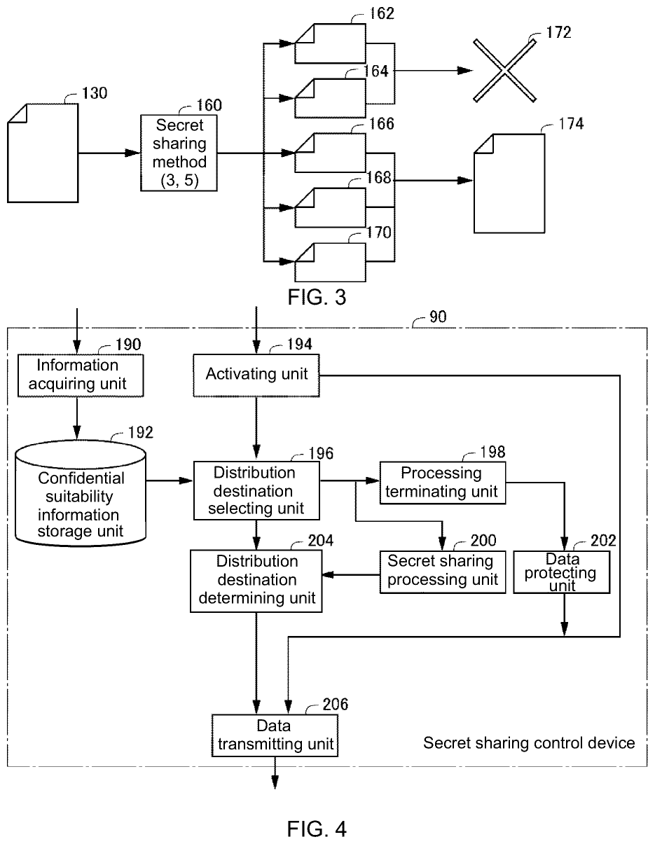

The secret sharing method will be described with reference to FIGS. 2 and 3, focusing on a portion that is related to the present disclosure. As used herein, the term “secret sharing method” refers to a technique for protecting data by dividing the data into a plurality of fragments (shares) and distributing the plurality of fragments (shares) to a plurality of distribution destinations. If the plurality of fragments include a number of shares corresponding to a number greater than or equal to a predetermined value, the original data can be restored. However, if the plurality of fragments include a number of shares corresponding to a number less than the predetermined value, the original data cannot be restored. The predetermined value used here will be referred to as “threshold value”, and the total number of fragments will be referred to as “the total number of shares”.

Referring to FIG. 2, an example will be described in which, for example, the total number of shares is set to 3, and the threshold value is set to 2. In the present embodiment, the secret sharing method used in this example will be expressed as “secret sharing method (2, 3)”. In this case, by applying the secret sharing method (2, 3) 132 to confidential data 130, which is data required to be protected (hereinafter referred to as “confidential data”), three shares including a share 134, a share 136, and a share 138 are generated. If it is possible to acquire, out of these shares, for example, the shares 136 and 138, confidential data 142 that is the same as the confidential data 130 can be restored. That is, even if the share 134 is lost 140, the confidential data 142 that is the same as the confidential data 130 can be restored. Even if the share 134 is leaked, with the share 134 alone, the threshold value (2) is not satisfied. Accordingly, the confidential data 130 cannot be restored.

Referring to FIG. 3, as another example, a secret sharing method (3, 5) 160 will be described. By applying the secret sharing method (3, 5) 160 to confidential data 130, five shares including a share 162, a share 164, a share 166, a share 168, and a share 170 are generated. Because the threshold value is set to 3, even if, for example, the shares 162 and 164 are leaked, with the shares 162 and 164 alone, the restoration of the confidential data 130 fails 172. Conversely, if the shares 166, 168, and 170 can be acquired, confidential data 174 that is the same as the confidential data 130 can be restored.

As described above, with the secret sharing method, even if a portion of the shares is leaked, as long as the total number of shares is less than the threshold value, the protection of secret data is maintained. Also, even if a portion of the shares is lost, as long as the total number of remaining shares is greater than or equal to the threshold value, the original data can be restored. As a result, with the secret sharing method, the data protection can be robustified.

### Secret Sharing Control Device

FIG. 4 shows a functional configuration of the secret sharing control device 90. Referring to FIG. 4, the secret sharing control device 90 includes: an information acquiring unit 190 that acquires distribution destinations of shares obtained through secret sharing, or in other words, information required to determine appropriateness as transmission destination information processing units from information processing units such as ECUs that are connected to the in-vehicle network 62 that is connected to the information processing device 70 via the network I/Fs 92 and 94. The acquired information indicates suitability of the information processing units as the distribution destinations of shares obtained through secret sharing, and thus will be referred to as “confidential suitability information” in the present embodiment. The secret sharing control device 90 further includes a confidential suitability information storage unit 192 for storing the confidential suitability information acquired by the information acquiring unit 190. The confidential suitability information storage unit 192 is implemented using, for example, a database that resides in a main memory of an information processing device that implements the secret sharing control device 90.

An example of the confidential suitability information will be shown below. In the confidential suitability information, security reliability indicates a basic security function. Redundancy of communication and redundancy of power supply have an effect of robustifying data protection by reducing the probability of losing confidential data when a problem occurs with communication and power supply. As used herein, the term “redundancy of communication” is not limited to the total number of relay devices connected as described below, and may include the total number of available communication media, the total number of usable protocols, and the like. Likewise, available memory capacity also has the effect of robustifying data protection by enhancing share storage reliability and also enhancing operational reliability of the security function of the system. The memory capacity is not limited to a secure memory, and may be an ordinary memory.

TABLE 1

| | | First selection | Second selection |
|---|---|---|---|
| Item | Case example | criteria | criteria |
| Security | OS version, app version | Whether the | Whether the |
| reliability | Whether basic security | condition on | condition on |
| | countermeasure function | the left side | the left side |
| | (firewall, IDPS, encryption, | is satisfied? | is satisfied? |
| | authentication, or the like) | | |
| | is provided or being | | |
| | operated? | | |
| | Whether cyber attach has | | |
| | been detected? | | |
| Redundancy of | Total number of relay | 2 or more | 1 or more |
| communication | devices connected | | |
| Redundancy of | Total number of power | 2 or more | 1 or more |
| power supply | supply devices connected | | |
| Memory | Memory capacity usable | Equal to data | Equal to data |
| capacity | by secure memory | size of shares or | size of shares or |
| | | greater than or | greater than or |
| | | equal to | equal to |
| | | threshold value | threshold value |
| | | that is a certain | that is a certain |
| | | multiple of data | multiple of data |
| | | size of shares | size of shares |

As will be described later, in order to determine to which of the network-connected devices the shares are to be distributed, a score is calculated for each device based on the confidential suitability information of the device, and the shares are preferentially distributed from a device with the highest score in descending order of the score. As the score calculating method performed at this time, any method can be used. For example, a method in which the score is calculated based on only one of the items described above (other items may also be used), a method in which the score is calculated by assigning a predetermined weight to two or more items of the items described above or other items and adding them up, or the like can be used. In either case, a minimum condition required to be satisfied may be set. For an item that may take various values such as memory capacity, a predetermined weight may be assigned to its real value, and used as an element of the score.

The secret sharing control device 90 further includes: an activating unit 194 that receives data from another device, activates processing that is based on the secret sharing method when a predetermined data concealing condition is established, and otherwise performs ordinary data transfer; and a distribution destination selecting unit 196 that is activated by the activating unit 194, and selects, based on the confidential suitability information stored in the confidential suitability information storage unit 192, candidates for distribution destinations of the shares obtained from the data using the secret sharing method from among the plurality of information processing units that are connected to the in-vehicle network 62. The total number of distribution destinations selected at this time is represented by D.

The data concealing condition may be a condition that determines, for example, whether a data concealing request has been transmitted together with the data from the data transmission source. Another condition may be a condition that determines whether to conceal the data based on which application of which ECU the data was transmitted. Furthermore, still another condition may be a condition that analyzes the content of the data, and when a specific pattern is detected in the data, determines that the data is required to be concealed. Alternatively, these conditions may be changed as needed by externally storing a condition for designating one of these conditions.

The secret sharing control device 90 further includes: a processing terminating unit 198 that, in response to the distribution destination selecting unit 196 determining, during processing, that the processing that is based on the secret sharing method cannot be performed, terminates the processing that is based on the secret sharing method, and activates another data protecting processing; and a data protecting unit 202 that, in response to the processing that is based on the secret sharing method being terminated by the processing terminating unit 198, executes, on the data, protecting processing that is based on another data protecting method.

The secret sharing control device 90 further includes: a secret sharing processing unit 200 that, in response to the distribution destination selecting unit 196 determining that the processing that is based on the secret sharing method can be performed, executes, on the data, processing that is based on a predetermined secret sharing method to generate a predetermined number of shares; a distribution destination determining unit 204 that determines share distribution destinations and shares to be distributed to the share distribution destinations from among the predetermined number of shares generated by the secret sharing processing unit 200 and the candidates for distribution destinations selected by the distribution destination selecting unit 196; and a data transmitting unit 206 that transmits the shares determined by the distribution destination determining unit 204 to the distribution destinations determined by the distribution destination determining unit 204.

The distribution destination selecting unit 196 compares a threshold value k set in the secret sharing method executed by the secret sharing processing unit 200 with the total number D of candidates for distribution destinations selected by the distribution destination selecting unit 196. If the total number D is less than the threshold value k, the distribution destination selecting unit 196 determines that the processing that is based on the secret sharing method cannot be performed. Otherwise, the distribution destination selecting unit 196 determines that the processing that is based on the secret sharing method can be performed.

### Program Structure

### Determining Distribution Destination ECU Candidates

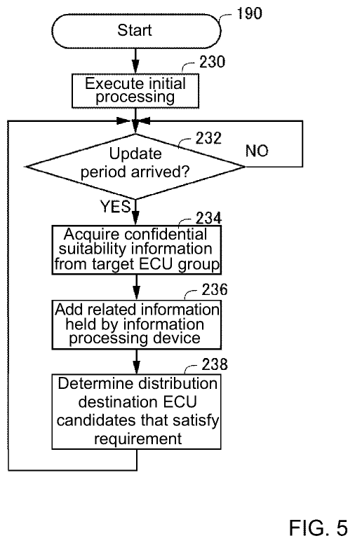

FIG. 5 shows a flowchart illustrating a control structure of a program that implements, using a computer, the information acquiring unit 190 and the distribution destination selecting unit 196 shown in FIG. 4. Referring to FIG. 5, this program includes: step 230 of executing initial processing such as ensuring storage areas to be used and initializing the storage areas using a predetermined initial value; step 232 of standing by until an update period for updating the candidates for distribution destinations arrives; and step 234 of, in response to the update period for updating the candidates for distribution destinations arriving, acquires confidential suitability information from ECUs included in a target ECU group (the devices included in the in-vehicle network 62 shown in FIG. 1).

This program further includes: after step 234, step 236 of adding, to the confidential suitability information, information that affects the confidential suitability of each of the devices connected to the in-vehicle network 62 such as information held by the information processing device 70 (a network relay table, topology information, and the like), and storing the confidential suitability information in the confidential suitability information storage unit 192; and step 238 of determining, based on the confidential suitability information acquired in steps 234 and 236, ECUs that satisfy a predetermined requirement, or in other words, ECUs that can be candidates for distribution destinations, and returning the flow of control to control step 232. The total number of ECUs determined at this time is the total number D described above.

### Secret Sharing Method

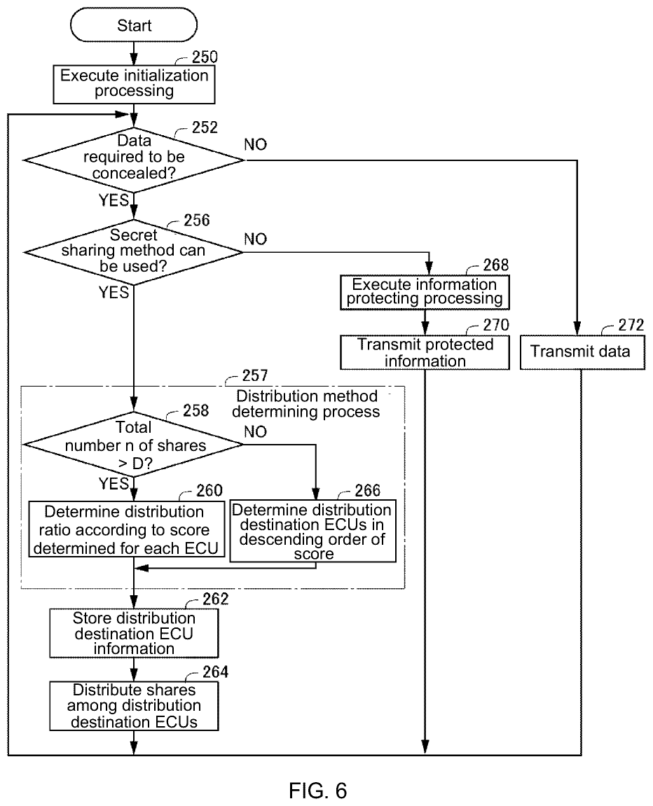

FIG. 6 shows a control structure of a program that implements the data processing that is based on the secret sharing method performed by the secret sharing control device 90 shown in FIG. 4. Referring to FIG. 6, this program includes: step 250 of executing a predetermined initialization processing; step 252 of standing by until data is received, and, in response to data being received, determining whether the received data is data to be subjected to concealing processing that is based on the secret sharing method, and branching the flow of control according to the determination made; step 272 of, in response to a negative determination being made in step 252, transmitting the received data to a designated transmission destination, and returning the flow of control to step 252.

This program further includes: step 256 of, in response to a positive determination being made in step 252, determining whether the total number of candidates for distribution destinations determined in step 238 shown in FIG. 5 is greater than or equal to the threshold value k set in the secret sharing method executed by the secret sharing processing unit 200 (see FIG. 4), and branching the flow of control according to the determination made; step 268 of, in response to a negative determination being made in step 256, executing, on the data, pre-set protecting processing that is different from the secret sharing method; and step 270 of transmitting the data (protected information) that has undergone the protecting processing in step 268 to a designated transmission destination, and returning the flow of control to step 252.

The protecting processing executed in step 268 may be any protecting processing as long as it can be executed under a given condition using a method other than the secret sharing method. For example, the protecting processing may be processing of encrypting the data using a public key of the transmission destination or a common key.

This program further includes distribution method determining process 257 that is a step of, in response to a positive determination being made in step 256, or in other words, when the total number D of distribution destinations is greater than or equal to the threshold value k set in the secret sharing method and the secret sharing method is applicable, determining a method for distributing the shares among the distribution destinations in accordance with a determining method determined based on a relationship between a total number n of shares and the total number D of distribution destinations. More specifically, the distribution method determining process 257 includes: step 258 of, when a negative determination is made in step 256, determining whether the total number n of shares is greater than the total number D, and branching the flow of control according to the determination made; step 260 of, when a positive determination is made in step 258, determining a distribution ratio of distributing the shares among the ECUs according to a confidential suitability condition (score value) of each ECU that can be a candidate for distribution destination; and step 266 of, when a negative determination is made in step 258, determining distribution destination ECUs from a distribution destination ECU with the highest confidential suitability condition (or the highest score) in descending order of the confidential suitability condition (or the score).

In step 260, for example, the total number of shares to be distributed among the ECUs may be determined according to the score calculated based on the confidential suitability information. On the other hand, with the method performed in step 266, only one share is distributed from the ECU with the highest score in descending order of the score, and no share is distributed to an ECU with a low score.

This program further includes: after steps 260 and 266, step 262 of storing information regarding the distribution destination ECUs in a predetermined storage device; and step 264 of distributing the shares generated as a result of the secret sharing processing unit 200 shown in FIG. 4 dividing the data among the distribution destination ECUs according to the condition determined in step 260 or step 266, and returning the flow of control to step 252.

As a result of the share distribution destinations being stored in step 262, when restoring the confidential information from the shares, it is possible to determine from which ECU the data should be collected.

### Restoring Confidential Data

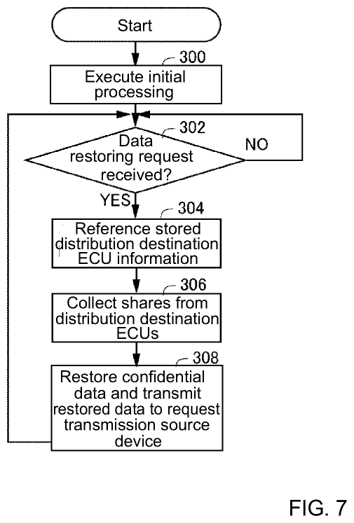

FIG. 7 shows a control structure of a program that implements restoring processing (not shown in FIG. 4) executed by the secret sharing control device 90 when a request to restore original data from shares distributed among a plurality of ECUs is received. Referring to FIG. 7, this program includes: step 300 of executing a predetermined initial processing; step 302 of standing by until a request to restore confidential data is received; and step 304 of, in response to the request to restore confidential data being received in step 302, reading out information regarding distribution destination ECUs to which shares of the confidential data were distributed from the storage device in which the information regarding the distribution destinations was stored in step 262 shown in FIG. 6 by referencing the storage device.

This program further includes step 306 of collecting the shares from the distribution destination ECUs based on the information read-out in step 304; and step 308 of restoring the original confidential data based on the shares collected in step 306, transmitting the restored data to the transmission source device of the request to restore confidential data, and returns the control to step 302.

In step 306, it is only necessary to collect at least a number of shares corresponding to a number equal to the threshold value, and it is unnecessary to collect more than that. Needless to say, it is also possible to collect a number of shares corresponding to a number greater than the threshold value, or it is also possible to restore the confidential data from a combination of different shares, and comparing them.

### Operation

Referring to FIG. 4, when the activating unit 194 receives data, the activating unit 194 determines whether a predetermined data concealing condition is established. If it is determined that the data concealing condition is not established, the activating unit 194 performs ordinary data transfer. If it is determined that the data concealing condition is established, the activating unit 194 activates the distribution destination selecting unit 196. The distribution destination selecting unit 196 selects candidates for distribution destinations of the shares from among the plurality of information processing units that are connected to the in-vehicle network 62 based on the confidential suitability information stored in the confidential suitability information storage unit 192. The total number of distribution destinations selected at this time is represented by D.

If it is determined that the total number D of distribution destinations selected is less than the threshold value k set in the secret sharing method executed by the secret sharing processing unit 200, the distribution destination selecting unit 196 determines that the processing that is based on the secret sharing method cannot be performed. In this case, the processing terminating unit 198 terminates the processing that is based on the secret sharing method executed by the secret sharing processing unit 200. The processing terminating unit 198 further activates the data protecting unit 202. The data protecting unit 202 executes protecting processing on the data based on a pre-set data protecting method that is different from the secret sharing method, and transmits the data that has undergone the protecting processing to the transmission destinations via the data transmitting unit 206.

If the distribution destination selecting unit 196 determines that the processing that is based on the secret sharing method can be performed, the secret sharing processing unit 200 executes the processing that is based on the secret sharing method on the data to generate a predetermined number n of shares. The distribution destination determining unit 204 determines share distribution destinations and shares to be distributed among the distribution destinations based on the number n of shares generated by the secret sharing processing unit 200 and the candidates for distribution destinations selected by the distribution destination selecting unit 196. This distribution method is determined in steps 258 to 266 shown in FIG. 6. The data transmitting unit 206 transmits the shares determined by the distribution destination determining unit 204 to the distribution destinations determined by the distribution destination determining unit 204.

As described above, in the present embodiment, when determining share distribution destinations using the secret sharing method, by taking into consideration the confidential suitability condition of distribution destination ECUs, a share is preferentially distributed from a distribution destination ECU with the highest level of confidential suitability. For this reason, as compared with a configuration that does not taking into consideration the confidential suitability condition of distribution destinations, the risk of outside leakage of shares can be reduced, and thus the data protection can be robustified. Also, the total number of ECUs that can be candidates for distribution destinations may be compared with the total number of shares, and the share distribution method may be changed according to the result of the comparison such that the protection of data in the ECUs can be robustified as much as possible. As a result, an optimal distribution method can be selected based on a relationship between the total number of ECUs that can be candidates for distribution destinations and the total number of shares, and thus the data protection can be robustified.

### Variation

In the embodiment described above, the total number n of shares is determined in advance. However, the present disclosure is not limited to the embodiment. For example, the total number n of shares may be changed according to the total number D of ECUs as candidates for distribution destinations. This configuration will be described below as a variation.

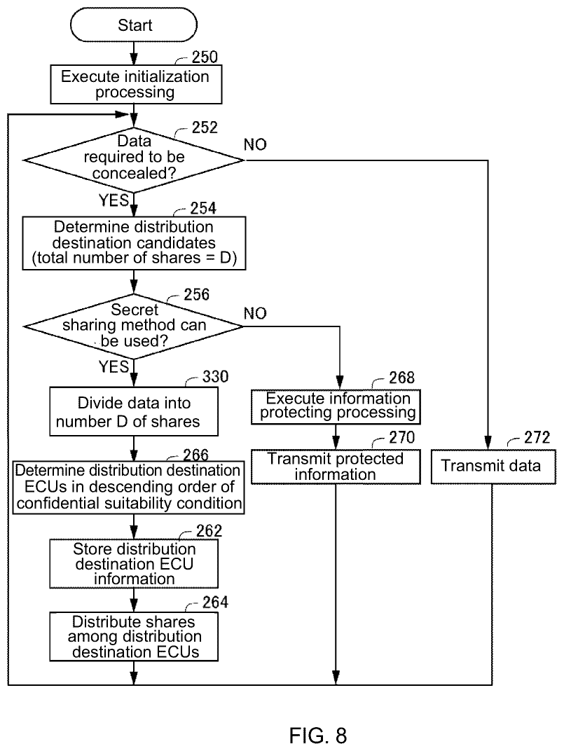

FIG. 8 is a flowchart according to the present variation showing an example that can be used instead of FIG. 6. The flowchart shown in FIG. 8 is different from that shown in FIG. 6 in that the flowchart shown in FIG. 8 does not include step 260 shown in FIG. 6, and includes, instead of step 258 shown in FIG. 6, step 330 of dividing the data to be concealed into a number D of shares, and also includes, after step 330, step 266 shown in FIG. 6. After step 266, the same processing as that in step 262 and the subsequent step shown in FIG. 6 is performed.

In short, the present variation is different from the first embodiment in which the total number of shares is fixed in advance, in that the total number n of shares is set to be equal to the total number D of candidates for distribution destinations determined in step 254. In this example, n=D is set, but n may be set as a general function of D. In this case, in general, this function is an increasing function of D.

According to the present variation, the total number of shares is changed according to the total number of candidates for distribution destinations. For this reason, even when the total number of candidates for distribution destinations is changed, there is no significant change in the total number of share distribution destinations, and thus the secret sharing method can be stably used. As a result, the data protection can be robustified.

### Second Embodiment

### Configuration

### Overall Configuration

In the first embodiment, no consideration is given to networks to which the distribution destination ECUs belong. However, in the case where, for some reason, data leakage occurs from an ECU of a network, it is appropriate to consider that the other ECUs that belong to the same network have a higher data leakage risk than the ECUs that belong to another network. On the other hand, in the case where shares are distributed among ECUs that are provided in a plurality of networks in a distributed manner, conversely, there may be a high risk of occurrence of data leakage in any of the plurality of networks. The above-described two cases can occur, and it is therefore desirable to select either one based on the network management policy.

In order to address the above-described problems, a second embodiment is configured to be able to cope with both of the cases where: share distribution destinations are provided in a plurality of networks in a distributed manner; and share distribution destinations are provided concentratedly in a specific network. Needless to say, it is also possible to cope with a case therebetween. However, in the embodiment described below, in order to simplify the description, it is assumed that the share distribution destinations can be switched between ECUs that are provided in all networks connected to the secret sharing control device in a distributed manner and ECUs that belong to a specific network.

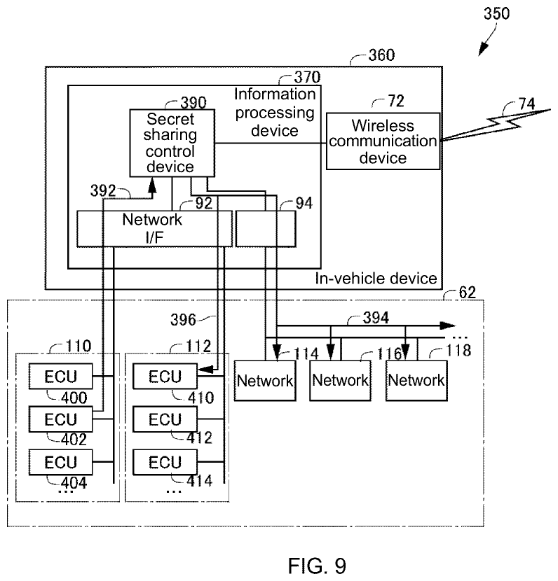

FIG. 9 shows an overall configuration of an in-vehicle system 350 according to the second embodiment. Referring to FIG. 9, the in-vehicle system 350 includes an in-vehicle device 360 and an in-vehicle network 62 that is connected to the in-vehicle device 360. The in-vehicle network 62 has the same configuration as that shown in FIG. 1.

The in-vehicle device 360 includes an information processing device 370 and a wireless communication device 72 that is connected to the information processing device 370. The information processing device 370 includes: a secret sharing control device 390 according to the second embodiment; a network I/F 92 that is a communication interface between the secret sharing control device 390 and networks 110 and 112; and a network I/F 94 that is a communication interface between the secret sharing control device 390 and networks 114, 116, and 118.

FIG. 9 shows a first operation mode of the in-vehicle system 350. In the first operation mode, it is assumed, for example, that data 392 is transmitted together with a concealing request from an ECU 402 to the information processing device 370. In this case, the secret sharing control device 390 of the information processing device 370 selects ECUs from the networks 112, 114, 116, and 118, and the like that are highly independent of each other, and delivers the shares as indicated by 394 and 396 as delivery destinations shown in FIG. 9.

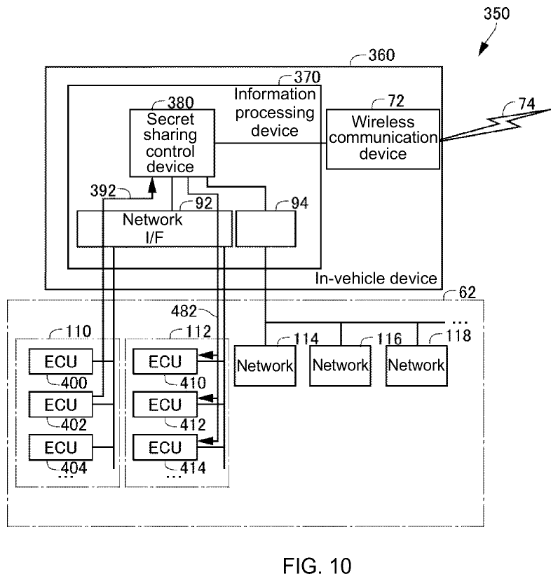

FIG. 10 shows a second operation mode of the in-vehicle system 350. In the second operation mode, it is assumed, for example, that data 392 is transmitted together with a concealing request from the ECU 402 to the information processing device 370. In this case, the secret sharing control device 390 of the information processing device 370 delivers the shares to, for example, only the ECUs provided in the network 112 as indicated by 482.

Whether the in-vehicle system 350 operates in the first operation mode shown in FIG. 9 or the second operation mode shown in FIG. 10 can be set from the outside.

### Secret Sharing Control Device

The secret sharing control device has the same configuration as the configuration shown in FIG. 4, except that, in the present embodiment, information for designating the operation mode is provided from the outside, and functions implemented by the distribution destination selecting unit 196 and the distribution destination determining unit 204 are different from the configuration shown in FIG. 4 according to the operation mode. The differences in the configuration are mainly due to a program. Accordingly, hereinafter, a structure of the program that implements the distribution destination selecting unit 196 and the distribution destination determining unit 204 in the present embodiment will be described.

### Program Structure

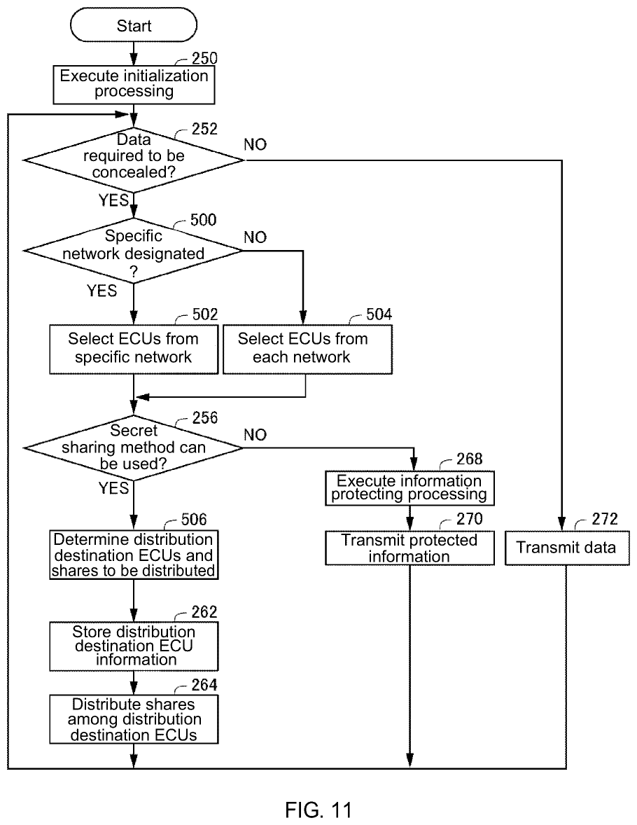

Referring to FIG. 11, the program that implements the distribution destination selecting unit 196 and the distribution destination determining unit 204 in the present embodiment includes steps 250, 252, and 272 that are the same steps as those shown in FIG. 6. This program further includes step 500 of, in response to a positive determination being made in step 252, determining whether a specific network from which share distribution destinations are to be selected has been designated, and branching the flow of control according to the determination made.

This program further includes: step 502 of, in response to a positive determination being made in step 500, selecting share distribution destination ECUs only from the designated specific network; and step 504 of, in response to a negative determination being made in step 500, selecting ECUs that satisfy a condition from the networks.

This program further includes: step 256 executed after steps 502 and 504; steps 268 and 270 executed when a negative determination is made in step 256; and step 506 of, when a positive determination is made in step 256, determining distribution destination ECUs and shares to be distributed among the ECUs. Step 506 will be described in detail.

This program further includes steps 262 and 264 executed after step 506.

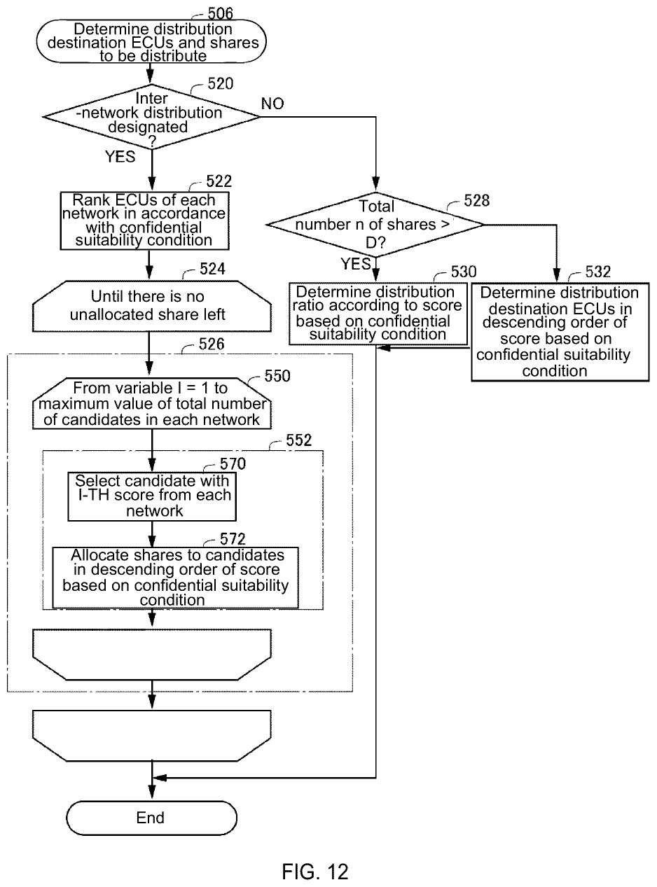

Referring to FIG. 12, step 506 shown in FIG. 11 includes: step 520 of determining whether inter-network distribution of the shares has been designated, and branching the flow of control according to the determination made; step 522 of, when a positive determination is made in step 520, ranking ECUs of each of the networks in accordance with the confidential suitability condition; and step 524 of repeatedly executing step 526 until there is no unallocated share left. In step 522, the ECUs are scored in accordance with the confidential suitability condition and ranked. At this time, an ECU whose score is less than a predetermined value is excluded from the share distribution destinations.

Step 526 includes step 550 of repeatedly executing step 552 while incrementing, by one, variable I that indicates the score ranking in each of the networks from 1 until a maximum value of the total number of candidates in each network is reached.

Step 552 includes: step 570 of selecting a distribution destination candidate with the I-th score from each of the networks; and step 572 of allocating the shares to the candidates selected from the networks in step 570 from a candidate with the highest score determined based on the confidential suitability condition in descending order of the score. At this time, as for a network in which only a small number of ECUs has been selected in step 522, there may be a case where there is no candidate left as the value of the variable I increases. In this case, no ECU is selected from the network.

This program further includes step 528 of, when a negative determination is made in step 520, determining whether the total number n of shares is greater than the total number of ECUs selected in step 502 or 504 shown in FIG. 11, and branching the flow of control according to the determination made; step 530 of, when a positive determination is made in step 528, determining the share distribution ratio for each ECU according to the score calculated based on the confidential suitability condition of the ECU and terminating step 506; and step 532 of, when a negative determination is made in step 528, determining distribution destination ECUs in descending order of the score and terminating step 506. The processing performed in steps 528, 530, and 532 in the second embodiment is the same as the processing performed in steps 258, 260, and 266 shown in FIG. 6.

### Operation

Referring to FIGS. 9 and 10, operations of the in-vehicle system 350 in the first operation mode and the second operation mode will be described separately.

### First Operation Mode

As shown in FIG. 9, the first operation mode is an example in which ECUs are selected from those provided in the networks in a distributed manner and the shares are distributed thereto. For example, as shown in FIG. 9, it is assumed that data 392 is transmitted together with a concealing request from the ECU 402 to the information processing device 370. The secret sharing control device 390 executes the program shown in FIGS. 11 and 12 in response to receiving the data and the concealing request. In this case, no specific network has been designated.

Referring to FIG. 11, this program receives, in step 252, the concealing request and the data. The determination made in step 252 is positive, and thus step 500 is executed. In the first operation mode, no specific network has been designated. Accordingly, the control proceeds to step 504, where the secret sharing control device 390 selects, from among the ECUs that belong to the in-vehicle network 62, ECUs whose score calculated based on the confidential suitability condition is greater than or equal to a predetermined value. Next, in step 256, whether the secret sharing method is applicable is determined. More specifically, it is determined whether the total number of ECUs selected in step 504 is greater than or equal to the threshold value k set in the secret sharing method. When a positive determination is made, the control proceeds to step 506. When a negative determination is made, the control proceeds to step 268. The processing performed in steps 268 and 270 is the same as that of the first embodiment.

Referring to FIG. 12, in step 520 of step 506, it is determined whether network distribution has been designated. In this example, a positive determination is made, and thus step 522 is executed. That is, in step 522, the ECUs selected from each of the networks are ranked in accordance with the confidential suitability condition. After that, step 524 is executed.

In step 524, step 526 is repeatedly executed until there is no unallocated share left. In step 570, first, variable I=1 is set, and an ECU with the highest score is selected from each of the networks. Next, in step 572, the ECUs selected in step 570 are ranked based on the score, and the shares are allocated to the ECUs in descending order of the score.

Next, the value of the variable I is incremented to 2. In step 570, an ECU with the second highest score is selected from each of the networks. Next, in step 572, the ECUs are ranked based on the score, and the shares are allocated to the ECUs in descending order of the ranking.

When the value of the variable I is incremented as described above, there may be a network with no candidate. In this case, the network is excluded from the networks from which ECUs are selected.

As a result of the above-described processing being repeated, when there is no unallocated share left, the processing in step 526 ends at this time. If there is an unallocated share is still left even after the shares have been allocated to all ECU candidates by repeating the above-described processing, the value of the variable I is set back to 1, and step 552 is again executed. In this way, when there is eventually no unallocated share left, the execution of step 524 ends.

On the other hand, when a negative determination is made in step 520, in step 528, it is determined whether the total number n of shares is greater than the total number D of ECUs as candidates. When a positive determination is made, step 530 is executed, and the shares are distributed among the ECUs at a ratio according to the scores calculated based on the confidential suitability condition of the ECUs. When a negative determination is made in step 528, step 532 is executed, and distribution destination ECUs are determined in descending order of the score.

As described above, in the present embodiment, it is possible to designate whether to distribute the shares to ECUs that belong to as many different networks as possible, or only to ECUs that belong to a specific network. As a result, with the selectable configuration according to the environment and the system design philosophy, robust data protection can be implemented.

### Hardware Configuration

Each of the information processing devices according to the embodiments described above is implemented by a computer and a program executed by the hardware of the computer.

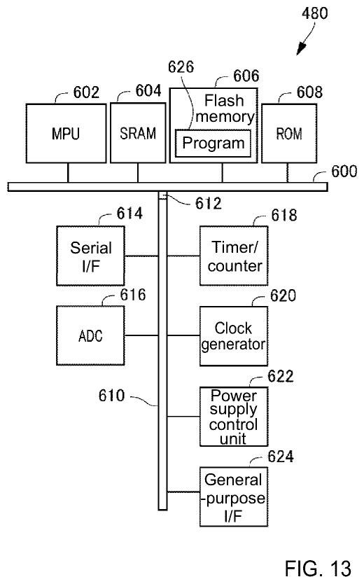

Referring to FIG. 13, a computer 480 includes: a micro processing unit (MPU) 602 that includes a central processing unit (CPU); a high-speed bus 600 that is connected to the MPU 602; a static random access memory (SRAM) 604 that is connected to the high-speed bus 600; a flash memory 606 that is connected to the high-speed bus 600; and a read-only memory (ROM) 608 that is connected to the high-speed bus 600. The SRAM 604 holds data required to execute programs. The flash memory 606 stores a program 626 for implementing the secret sharing control device and the functions implemented by the secret sharing control device. The ROM 608 stores a boot-up program for the computer 480 and the like.

The computer 480 further includes: a low-speed bus 610 that is connected to the high-speed bus 600 via a bridge 612; and a serial I/F 614, an analog-to-digital converter (ADC) 616, a timer/counter 618, a clock generator 620, a power supply control unit 622, and a general-purpose I/F 624 that are connected to the low-speed bus 610.

The operations of computers are well-known. The significance of the embodiments lies in the functions of a program executed by a computer. Accordingly, a description of the operations of computers will not be given.

Each processing (each function) of the embodiments described above is implemented by processing circuitry that includes one or more processors. The processing circuitry may be configured using an integrated circuit or the like in which, in addition to the one or more processors, one or more memories, various types of analog circuits, and various types of digital circuits are combined. The one or more memories store a program (command) that causes the one or more processors to execute each processing of the embodiments described above. The one or more processors may execute each processing of the embodiments described above in accordance with the program read out from the one or more memories or in accordance with a logic circuit designed to execute each processing of the embodiments described above in advance. The one or more processors may be various types of processors suitable for controlling computers such as a CPU, a graphics processing unit (GPU), a digital signal processor (DSP), a field-programmable gate array (FPGA), an application specific integrated circuit (ASIC), and the like. The plurality of processors that are physically separate from each other may execute each processing of the embodiments described above in cooperation with each other. For example, the processors included in the plurality of physically separate computers may execute each processing of the embodiments described above in cooperation with each other via a network such as a local area network (LAN), a wide area network (WAN), or the Internet. The program may be installed in the one or more memories from an external server device or the like via the network, or may be stored in a recording medium such as a compact disc read-only memory (CD-ROM), a digital versatile disc read-only memory (DVD-ROM), or a semiconductor memory, and distributed, and then installed in the one or more memories from the recording medium.

The embodiments disclosed in the present application are exemplary in all aspects, and thus should not be construed as limiting. The scope of the present disclosure is indicated by the appended claims rather than the description in the detailed description of the present disclosure, and all changes that come within the meaning and range of equivalency of the claims are intended to be embraced within the scope of the present disclosure.

1. A secret sharing control device comprising:
an information acquiring unit configured to acquire, from a plurality of information processing units that are connected to a network, confidential suitability information of the plurality of information processing units;
a distribution destination selecting unit configured to select distribution destinations of shares obtained from data using a secret sharing method from among the plurality of information processing units, based on the confidential suitability information acquired by the information acquiring unit; and
a distributing unit configured to distribute the shares obtained from the data using the secret sharing method among the information processing units selected by the distribution destination selecting unit.

2. The secret sharing control device according to claim 1, further-comprising: including;
an activating unit configured to, in response to data required to be concealed being received via the network, activate secret sharing processing that is performed on the data required to be concealed by the distribution destination selecting unit and the distributing unit.

3. The secret sharing control device according to claim 1, wherein the information acquiring unit collects, as the confidential suitability information, at least one of: security reliability of each of the plurality of information processing units; redundancy of communication media available to the plurality of information processing units; redundancy of power supply of the plurality of information processing units; and memory capacity available to the plurality of information processing units.

4. The secret sharing control device according to claim 1, further comprising-including;
a processing terminating unit configured to, in response to a total number of information processing units selected by the distribution destination selecting unit being less than a threshold value required by the secret sharing method to restore information, terminate processing performed on the data, which is data required to be concealed, using the secret sharing method.

5. The secret sharing control device according to claim 4, further including:
a data protecting unit configured to, in response to the processing performed on the data required to be concealed using the secret sharing method being terminated by the processing terminating unit, perform processing of protecting the data required to be concealed using a protection method that is different from the secret sharing method.

6. The secret sharing control device according to claim 4, wherein the distribution destination selecting unit determines, in response to the total number of distribution destinations being greater than or equal to the threshold value, a total number of the shares obtained using the secret sharing method to be equal to the total number of distribution destinations.

7. The secret sharing control device according to claim 4, wherein the distributing unit includes a distribution method determining unit configured to, in response to the total number of distribution destinations being greater than or equal to a threshold value set in the secret sharing method, determine a method for distributing the shares among the distribution destinations in accordance with a determining method determined based on a relationship between a total number of the shares and the total number of distribution destinations.

8. The secret sharing control device according to claim 7,
wherein the distribution method determining unit includes:
a first determining unit configured to, in response to the total number of distribution destinations being greater than or equal to the threshold value set in the secret sharing method and the total number of the shares being greater than the total number of distribution destinations, determine the total number of the shares to be distributed among the distribution destinations according to the confidential stabililty information of the distribution destinations; and
a second determining unit configured to, in response to the total number of distribution destinations being greater than or equal to the threshold value set in the secret sharing method and the total number of the shares being less than or equal to the total number of distribution destinations, determine the distribution destinations in order according to the confidential stability information of the distribution destinations.

9. The secret sharing control device according to claim 1, wherein the distribution destination selecting unit preferentially selects, as the distribution destinations, information processing units that belong to a highly independent network from among the plurality of information processing units, based on the confidential suitability information acquired by the information acquiring unit.

10. The secret sharing control device according to claim 1, wherein the distribution destination selecting unit preferentially selects, as the distribution destinations, information processing units that belong to a specific network from among the plurality of information processing units, based on the confidential suitability information acquired by the information acquiring unit.

11. An in-vehicle device comprising:
the secret sharing control device according to claim 1.

12. An in-vehicle system comprising:
an in-vehicle network;
a plurality of information processing units that are connected to the in-vehicle network; and
a secret sharing control device configured to apply a secret sharing method to data received from any one of the plurality of information processing units to generate a plurality of shares, and distribute the plurality of shares among a plurality of transmission destination information processing units selected from among the plurality of information processing units,
wherein the secret sharing control device includes:
an information acquiring unit that is connected to the in-vehicle network and acquires, from the plurality of information processing units, confidential suitability information of the plurality of information processing units;
a distribution destination selecting unit configured to select the plurality of transmission destination information processing units as distribution destinations of the plurality of shares obtained from the data using the secret sharing method from among the plurality of information processing units, based on the confidential suitability information acquired by the information acquiring unit; and
a distributing unit configured to distribute the plurality of shares obtained from the data using the secret sharing method among the plurality of transmission destination information processing units selected by the distribution destination selecting unit.

13. A secret sharing control method comprising:
an acquiring step of acquiring, from a plurality of information processing units that are connected to a network, confidential suitability information of the plurality of information processing units;
a selecting step of selecting distribution destinations of shares obtained from data using a secret sharing method from among the plurality of information processing units, based on the confidential suitability information acquired in the acquiring step; and
a distributing step of distributing the shares obtained from the data using the secret sharing method among the information processing units selected in the selecting step.

14. A computer program that causes a computer to function as:
an information acquiring unit configured to acquire, from a plurality of information processing units that are connected to a network, confidential suitability information of the plurality of information processing units;
a distribution destination selecting unit configured to select distribution destinations of shares obtained from data using a secret sharing method from among the plurality of information processing units, based on the confidential suitability information acquired by the information acquiring unit; and
a distributing unit configured to distribute the shares obtained from the data using the secret sharing method among the information processing units selected by the distribution destination selecting unit.
